(19) United States
(12) Patent Application Publication
(10) Pub. No.: US 2002/0023046 A1
(43) Pub. Date: Feb. 21, 2002

(54) System for automating business purchasing functions via a global computer network

(75) Inventors: Patrick Callahan, Wilton, CT (US); Michael Nydell, Newtown, CT (US)

Correspondence Address: LAW OFFICE OF BARRY R LIPSITZ, 755 MAIN STREET, MONROE, CT, 06468, US

(73) Assignee: Professor Mac, LLC, Southport, CT

(21) Appl. No.: 09/854,874

(22) Filed: May 14, 2001

Related U.S. Application Data
(60) Provisional application No. 60/205,857, filed on May 19, 2000.

(51) Int. Cl. G06F 17/60

(52) U.S. Cl. 705/37

(57) ABSTRACT

A Business-to-Business Web-based system is disclosed that automates the process of bidding, negotiating, reporting and purchasing of goods or services from vendors. A list of vendors and associated vendor parameters is stored in a database accessible to a computer processor. A user interface associated with the processor is provided to enable a user to specify procurement requirements. Rules are applied by the processor to select at least one potential vendor based on the vendor parameters and procurement requirements. The selected vendor(s) are contacted over a global communication network and invited to submit a bid. The bids are submitted back over the network and the system analyzes them to recommend a vendor to the user. Quality data is provided by the user upon completion of the job, and used in subsequent vendor selection sessions.

This application claims the benefit of provisional application 60/205,857 filed May 19, 2000.

### BACKGROUND OF THE INVENTION

The present invention relates to business productivity, and more particularly to a process for automating the acquisition, routing and processing of information relating to the purchase of products and services.

In the past, procurement of goods and services for businesses has been a multi-step process, involving many people and taking substantial time. Moreover, the procurement process has been subject to various inconsistencies, particularly relating to the selection of vendors and the prices paid. Various factors, such as past quality of service provided, were often overlooked. Therefore, the vendor selection process could easily result in bad choices being made, with disappointing outcomes.

It would be advantageous to provide an automated procurement system that does not suffer from the above-mentioned problems. Moreover, it would be advantageous to provide a procurement system that is computerized and enables all relevant organization employees to have access thereto, via the organization's intranet. It would be still further advantageous for such a system to communicate directly with vendors over a global communication network, such as the Internet. The present invention provides an automated procurement system having the aforementioned and other advantages.

In an illustrated embodiment, the invention is described in connection with the acquisition by a credit provider of credit card program materials for distribution to consumers, and the automation of this process all the way through the purchasing and delivery of printed materials. Communication of information to and from various parties in the acquisition, routing and processing stages is provided over a network, such as the Internet. It should be appreciated that although the invention is described in connection with a particular embodiment, the invention is applicable to any type of business information acquisition, routing and ultimate production, and is not limited to the specific embodiments disclosed herein. For example, the invention can be applied to corporate purchasing, and virtually every item purchased by a company can be directed through the inventive system. If all purchasing activity goes through the system, the data available to management for review will be very complete, and will remain easy and convenient to use.

Automation of such activities is advantageous because it will simplify and streamline the acquisition of items required by a business, such as printed materials and the like, and reduce any sources of errors. Since the process involves many steps and multiple groups, it is also of importance that the system eliminates re-keying of data and provides a convenient method of tracking the progress of a request for materials through its lifecycle. The primary focus of the system is to acquire all information about a request and track its progress throughout the system. Once all of the requirements are entered, the system also needs to provide intelligent vendor selection (e.g., the selection of a printer) based on capabilities, cost, timeline and quality.

The system should be accessible by any employee of the business that uses the system, wherever they are, as well as to the vendors that actually produce the end product, such as printed materials, a credit card, a promotional package, or the like. Generally, all of the information should be available for viewing by any employee, but only specific authorized users should be permitted to enter, modify or process the data.

The goal of the present invention is to automate and manage the entire business process of interest, such as the process of document creation for a plurality of different credit card programs. This includes the capturing of all the information required to create and deliver each required finished printed piece. The tracking of the process is critical to the efficiency of project delivery and this is an integral part of the present invention.

### SUMMARY OF THE INVENTION

In an illustrated embodiment, the system of the present invention is designed to select vendors for jobs, such as printing jobs, based on technical capabilities and past performance. Vendors who are selected to bid on a job submit their proposal with such qualifiers as cost and date of delivery. Generally, the vendor that can deliver on time with the lowest price is selected, although other criteria can be used for vendor selection.

When a job is complete, the vendor is given a performance rating. This score is fed back into the system to help select the best vendor for the next job.

More particularly, the invention provides an automated rule-based procurement system. The system includes at least one computer processor. A data store of vendors is accessible to the computer processor. A data store of vendor parameters relating to the vendors and accessible to the computer processor is provided for use in selecting vendors for a project. A user interface operatively associated with the processor enables dialog between a user and the rule-based system. The interface allows the user to specify requirements for the project. The rule-based system applies rules to select at least one potential vendor for the project based on the vendor parameters and the project requirements specified by the user.

A communication module is provided to communicate the project requirements to at least one selected vendor for solicitation of a bid on the project. In a preferred embodiment, the communication module communicates with the at least one selected vendor by e-mailing a link to the vendor. The link directs the vendor to a web page for accessing the project requirements. The selected vendors can then submit bids to the system via the web page. After the bids are received, the rule-based system applies rules to recommend one of the vendors to complete the project based on the received bids.

The rule-based system can also base its recommendation of a vendor on the vendor parameters. The user interface can permit a user to accept or override the system vendor recommendation. The system can also include a vendor notification module, for notifying vendors of the outcome of the bidding process.

A scoring module is provided for receiving input from the user interface as to the quality of the project when completed by a vendor. Data from the scoring module is stored in the data store of vendor parameters for use in subsequent vendor selection. The user interface can be implemented to permit a user to accept or override the system vendor selection.

A system administrator interface, which can be part of the user interface, enables an authorized administrator to manage at least one of the project specification process, the vendor data store, the vendor parameters, the user interface, the rules to be applied, and vendor communications.

The system can further comprise a reporting module responsive to the user interface for generating reports relating to the project.

Corresponding methods are also provided.

### BRIEF DESCRIPTION OF THE DRAWINGS

FIG. 1 is a block diagram of an implementation of the invention wherein a global sourcing process is provided over the Internet;

FIG. 2 is a flowchart illustrating the global sourcing process as applied to the bidding, purchase, delivery and performance of vendors for printed materials;

FIG. 3 is a block diagram illustrating the communication of a central processor with various business entities and vendors; and

FIG. 4 is a simplified block diagram showing the various components of the system from the perspective of a user.

### DETAILED DESCRIPTION OF THE INVENTION

The present invention provides a computerized system, available over a global communications network such as the Internet, to enable businesses to procure goods and services.

Various advantageous features of the invention include complete control over the procurement process, and trackability of the process. The tracking function includes tracking of sign-offs (e.g., by the appropriate manager), overrides, proofs and communications between company personnel and outside vendors. Controls can also be placed on the procurement process, e.g., to avoid unauthorized transactions. An informative reporting system is also provided.

A detailed explanation of how to use an example embodiment of the system is provided hereinafter. To facilitate an early understanding of the process, the following brief description of the process flow is provided:

a) A transaction category (e.g., purchase of a printing job) is selected.

b) The user drills down through required sub-menus via a graphical user interface (GUI).

c) An appropriate requisition or specification is filled out.

d) The requisition or specification is submitted to the system for selection of appropriate vendors to bid on the job.

e) The requisition is approved and/or edited (e.g., by an appropriate manager) and sent to the selected vendors, e.g., via e-mail.

f) The vendors respond, e.g., into their own client web center.

g) The system receives the responses from the vendors and completes a selection analysis.

h) With the aid of the system, the user negotiates and selects a final vendor.

i) Feedback notices are generated and sent (e.g., by e-mail) to each vendor that responded with a bid.

j) The final vendor delivers the job to the user and the vendor quality is scored

k) Reporting and financial analysis is available to the user upon request.

The system of the invention has various “roles.” A “role” is defined as the embodiment of a set of functionality within the system. It determines what parts of the system a user has access to and what functions they are allowed to perform.

When a system administrator adds a user to the system, he identifies the role(s) that this person performs. When that person logs in they are given the security rights assigned to their role(s) and are permitted to perform functions according to the definition of the role(s).

An Acquisitions Manager (“AM”) is responsible for maintaining all of the critical data in the system and administering the process.

A bid submitter (typically an employee of the vendor) submits bid information, such as time of delivery and cost, in response to a request for quotation (“RFQ”). In the preferred embodiment, a vendor may submit a bid only for a job for which they received an RFQ. Access to any other part of the system or any other job for which they did not receive an RFQ is not allowed. This person is always associated with a vendor.

An administrator maintains the integrity of the system by ensuring that it is being used properly, responding to system events and issues, and configuring the system to provide maximum flexibility.

A guest may view most of the information and run reports, but they are unable to modify any of the data. Other employees of the system user will log on using the guest account.

The technical capabilities for a job are designated in the job's Creative Specification. The system of the present invention can be implemented to require a very detailed specification in order to convey the information on a job. Therefore, a key function of the computer software used in connection with the inventive system is the creation and organization of these specifications. The portion of software that provides this functionality is referred to as the “Vendor Module.”

The system has various additional components. In the example embodiment, where the procurement is for printed materials, such additional components include:

Clients

Clients are the companies for which the documents are created and delivered. Client information includes name, address and contact information.

Each client is assigned an Acquisitions Manager. This person is the client's primary contact within the organization. The Acquisitions Manager is also the primary contact for a client's job-related issues.

The client may have one or more Branch Codes associated with it. A Branch Code is created for a specific type of Program. A Branch Code has at most one current Suite associated with it at one time.

Suites

A Suite embodies the legal terms and conditions that relate to a Client's Branch Code. Only one set of terms and conditions are valid for a Program at any one time.

Suites contain one or more documents.

Documents/Jobs

Documents are the physical materials that actually need to be created for a particular program. A Program may require the creation of many different types of documents (e.g., envelopes, mailers, brochures, letters, return postcards, and the like). The Document's content is dictated by a Legal Specification and its layout is determined from the Creative Specification.

A Document consists of many pieces:

Status/Review

As a Document is generated and processed, its status is tracked. Many groups are involved in approving the content of each Document—these approvals are tracked as well.

Creative Spec

A Document is requested by an organization employee in the form of a Job Request. A Job Request will result in the creation of exactly one Document. Each Job will have assigned to it a Job Number that is unique per Program.

Lettershop

Four color printing

Novelty printing

Miscellaneous

Proofs

A Proof is the mock up of the Document's layout. The system provides the capability to upload and view online the electronic versions of the Proofs.

Notes

Notes help to communicate issues and questions as they relate to a specific job. By keeping the notes, and their associated threads of conversation in one place, all pertinent information about a job are contained in one place.

Reprint

A Reprint is used when the Client has used up all of the previously printed Documents. Based on historical figures, it is possible to predict ahead of time when to issue a Reprint before the Client actually runs out.

Vendors

Vendors provide the materials designed by the Client company. They will have information such as name, address, telephone number, fax number and email address. Each vendor will also have numerous ratings associated with it as described in the Vendor Bidding Module.

Reports

Reports may be requested.

Users

The system identifies all users and applies access privileges. Usage is tracked based on user sign-on.

Once a Program exists, Jobs can be assigned to it. Once a Job Request is submitted, it begins its traversal through the system processes automatically.

A designated department of the procuring organization, such as the Client Development department, is typically responsible for creating Jobs. They provide up-to-date Client Contact information and any other information that overrides the Program as well as information specific to the Document in need.

For the review stage of the process, the type of document determines the groups that will be involved in reviewing it.

Various modules included in and processes performed by the inventive system are as follows:

Vendor Bidding Module

Initial Selection

There are many different types of printed materials that may be needed for each job. Moreover, different vendors have different abilities. Once the specifications for a job have been supplied, the system selects the top three vendors capable of providing the service(s) required. Each of these three vendors will receive a Request for Quote.

Vendor selection is based on each vendor's technical capabilities and past quality scoring. Technical capabilities are determined in advance, e.g., using a test package that also scores the vendors on time and cost to print. Each criterion can, for example, carry a score of 1 to 10. A total score for a job is the average of the scores required for the job. If a vendor does not have a capability required for a job, they are not scored.

The following is an example of how the top three vendors who have Technical Capabilities A & B would be selected:

| | | | | | Example Score |
|---|---|---|---|---|---|
| | Technical Capability | | | | for Job |
| | Rating | | | | Requiring |
| Vendor | A | B | C | D | A & B |
| 1 | 3 | | 9 | | 0 |
| 2 | 5 | 7 | | 7 | 6 |
| 3 | 6 | 4 | 8 | | 5 |
| 4 | | | 3 | 4 | 0 |
| 5 | 7 | 9 | | 2 | 8 |
| 6 | 6 | 8 | 7 | | 7 |

The winners would be Vendors 2, 5 and 6 because they have the highest score for the required capabilities.

Request for Quote (RFQ)

Once the three vendors have been selected, they each need to be contacted about the details of the job. A Request for Quote is generated, which describes the requirements of the job.

The system will either automatically e-mail each of the selected Vendors or await action from the organization employee who is requesting the bid. For example, the employee may decide to review the selections and override the selections. A return receipt can be requested to verify receipt of the e-mail. The e-mail will include a Web link to the Bid Submittal Web page, enabling the Vendor to obtain further information and respond to the RFQ.

Each RFQ will have an associated deadline after which bids are no longer valid. That value will be some configurable time, typically 24 or 48 hours.

Bid Submittal

When a vendor has prepared a bid, he will be able to submit the required information. The Vendor may decline the bid, or provide a cost estimate and estimated date of delivery.

Each Vendor will be assigned a user id and login in order to gain access to the system. The Web link will direct them to the proper job for which they are bidding. If the Vendor enters a bid after the deadline, the system will indicate the status but may accept the bid. The Vendor will be able to provide the estimated delivery date, price and any free-form comments.

Once a bid is submitted, the Vendor will be supplied a verification number to help them track their bid. The same Vendor will not be able to gain access to the system again for the same RFQ.

Final Selection

When the bid deadline has been reached or all the bids have been submitted, whichever comes first, the system recommends a vendor. The deadline is extended until at least one bid is received. Final vendor selection is based on:

highest weighted-score

lowest cost

timeline met

The total weighted-score is an average of:

A) Technical Capability score—calculated in the Initial Selection

B) Equipment Rating—capability to print in-house

C) External Service Rating—historical service levels based on past performance for the client and/or for a larger universe of customers

D) Internal Service Rating—service level of the client's (and/or others') experience with this Vendor (at the end of each job, the organization will rate this Vendor)

The following is an example of how the scoring would be applied to the three vendors that were initially selected.

| | Technical | | External | Internal | Total |
|---|---|---|---|---|---|
| | Capability | Equipment | Service | Service | Weighted |
| Vendor | Rating | Rating | Rating | Rating | Score |
| 2 | 6 | 8 | 8 | 6 | 7 |
| 5 | 8 | 9 | 6 | 5 | 7 |
| 6 | 7 | 8 | 9 | 8 | 8 |

This weighted-score is then included in the final selection, based on the values given by the Vendor for the job. The criteria are evaluated using timeline, cost and score. In the event of a tie, a Vendor who meets other requirements, such as completion of a quality training program, may help break the tie. An example of how Vendor 6 would be awarded the bid for a delivery date of Apr. 27, 2001 is as follows:

| | Vendor | | Total | |
|---|---|---|---|---|
| | Date of | Vendor | Weighted | Quality |
| Vendor | Delivery | Cost | Score | Training? |
| 2 | 4/21/2001 | $10,000.00 | 7 | Yes |
| 5 | 5/01/2001 | $9,500.00 | 7 | Yes |
| 6 | 4/27/2001 | $11,000.00 | 8 | No |

The organization that requested the bids is notified by e-mail that a Vendor has been chosen. The appropriate organization employee must enter the system, review the vendors' bids and scoring and accept the system's recommendation or select a different Vendor. The system will not proceed without the organization making the final decision.

The selected Vendor is e-mailed that its bid has been accepted and that they will be contacted with more information. The other Vendors will receive an e-mail indicating that their bids were not accepted.

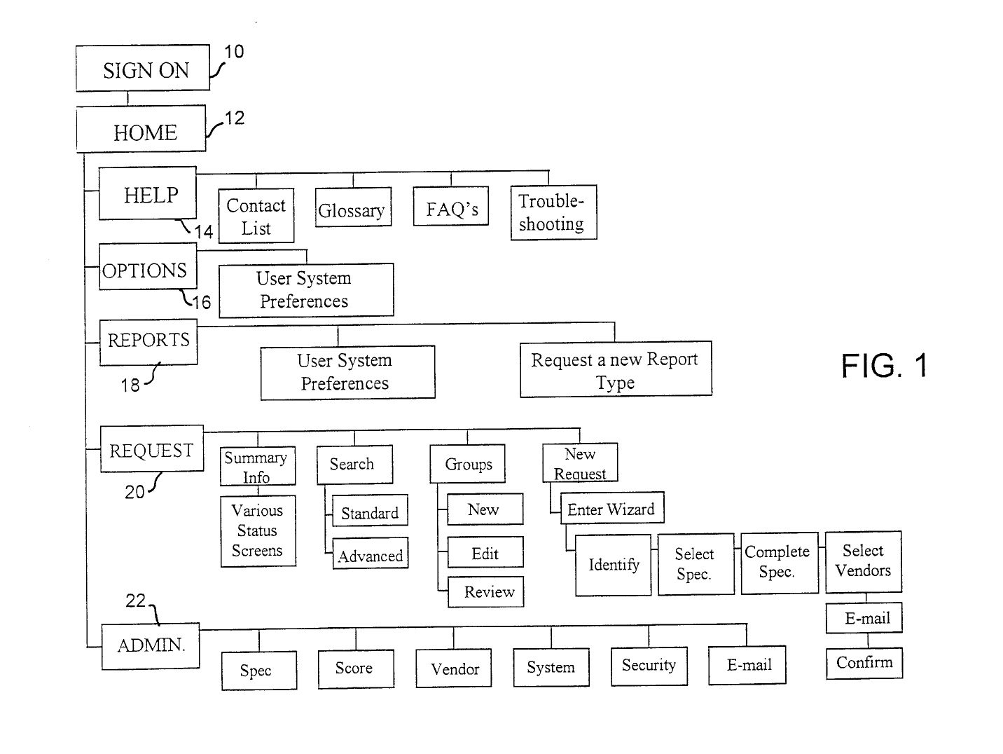

FIG. 1 illustrates the procurement system of the present invention in block diagram form. It will be apparent to those skilled in the art that the functional diagram of FIG. 1 can be readily implemented in software using well known and straightforward programming techniques.

As indicated in box 10 of FIG. 1, a user (either purchaser, vendor, or management seeking a report) signs on to the system, and is taken to an appropriate home page (box 12). The user can select from various functions from the home page, including help (box 14), options (box 16), reports (box 18), request (box 20) and administration (box 22). The help function enables a user to obtain a contact list, such as a list of vendors or clients, a glossary defining terms used by the system, answers to frequently asked questions (FAQ's) or troubleshooting assistance.

The options function allows the user to set preferences to customize the user interface and operation of the system.

The reports function allows the user to set preferences for reports that are generated by the system (such as, for example, formatting and printing options). This function also allows a user to request and specify a new report type, or to obtain a specific type of report from a predetermined list of available reports.

The request function allows the user to commence a new request for proposal (RFP) from a vendor. This is the main function of the system; i.e., to enable the procurement of a desired good or service using the automated features of the present invention. The request function enables the user to obtain summary information of an in-process or completed job. Various status screens are provided to the user upon a request for summary information.

The request function also enables a user to search the system in either a standard or an advanced mode. This feature makes information stored in the system databases, which may be either current or historical in nature, readily available to the user. Standard database search and retrieval techniques are used to implement the search capability.

A user can also work with job groups from the request function. New groups of personnel (or company departments) that will be involved in the procurement process can be defined. Existing groups of such personnel and departments can be edited. Existing groups can also be reviewed, upon request of an authorized user.

A new job (“new request”) can also be defined using the request function. A software “wizard” is advantageously provided to simplify the user interaction with the system and guide the user through the request process. In a first step, the job type and scope is identified by the user. Next, a specification template is selected. The specification is then completed, and vendors are selected. The vendors are contacted (e.g., via e-mail) to bid on the job, and confirmation is provided by the vendor that the bid documents have been received.

Administration functions, as shown in FIG. 1, include management of the specifications for various jobs, management of the vendor scorecard, management of vendors, management of system settings and options, user management and security, and e-mail management. The administration functions will generally be limited to specified personnel who are charged with managing the system. For example, conventional password techniques can be utilized to limit access to the administration function. Other functions of the system can also be password limited.

A good measure of the flexibility and robustness of a computer software application, such as the application provided by the present invention, is its ability to be easily configured and reconfigured as the parameters of the system change. It is recommended that one or more administrators will be assigned to maintain the data within the application. Entry points will include:

Vendors

Capabilities

Users

Roles

Processing rules and flow

Document Types and Review Parties

Exception Handling

Interfaces to external systems

Other system parameters

Administrative modules and tools can be as simple or sophisticated as desired. The more complex the tool is the more time that is involved in creating and testing the functionality.

The software application of the present invention can be deployed, for example, using Microsoft technology. Those skilled in the art will realize that other technologies, such as those available under the LINUX, UNIX or other operating systems can also be used to implement the inventive system. Since global access for both employees and vendors is required, the application is deployed as a Web site.

In a preferred embodiment, the system is implemented using a 3-tiered approach. The tiers are: data, business logic and user interface. The data component can be implemented, for example, using a relational database under Microsoft SQL Server. Other well known and commercially available databases can alternatively be used. The business logic can exist as a combination of stored procedures, e.g., on SQL Server, and ASP components running, e.g., on Microsoft Internet Information Server 4.0 (IIS). The user interface can consist of Hyper-Text Markup Language (HTML) and Active Server Pages (ASP) web pages served up to the user's browser by IIS.

There are three server-side components that are part of the system. In an implementation using Microsoft products, these are:

SQL Server

IIS

Transaction Server/Site Server

Exchange Server

It is recommended that the SQL Server component reside on its own machine. SQL Server is a high maintenance, CPU-hungry service. By isolating it, reboots and CPU spikes will minimize impact on other applications. This machine needs to be networked so that the Web server can gain access to the data and so that it has access to Exchange. Exchange Server can be used to send mail from the system. An IIS-resident mail component can be utilized to enable transmission of e-mail from the application.

The Web site can reside on a server running IIS. Optimum performance will be attained if the server running IIS is a separate machine from the one running SQL Server.

Users will gain access to the system through their Web browser. As long as they are granted access and know the address of this site, they will be able to access and use it. They will be able to perform functions according to the security rights assigned to them by the Administrator.

The application is preferably designed by taking into consideration Browser limitations dictated by the client. The selected platform will determine the amount of extra front-end functionality and presentation. Base functionality of the application is a constant; however, the amount of work done client-side versus server-side should be carefully weighed during every step of the development. Technologies that come into question will include HTML, DHTML, ASP, JavaScript, VBScript, ActiveX, etc. It should be appreciated that the system can be implemented using any other suitable development software or operating system. Examples include, without limitation, Oracle, Sybase, UNIX/LINUX, and various programming languages, as well known in the art.

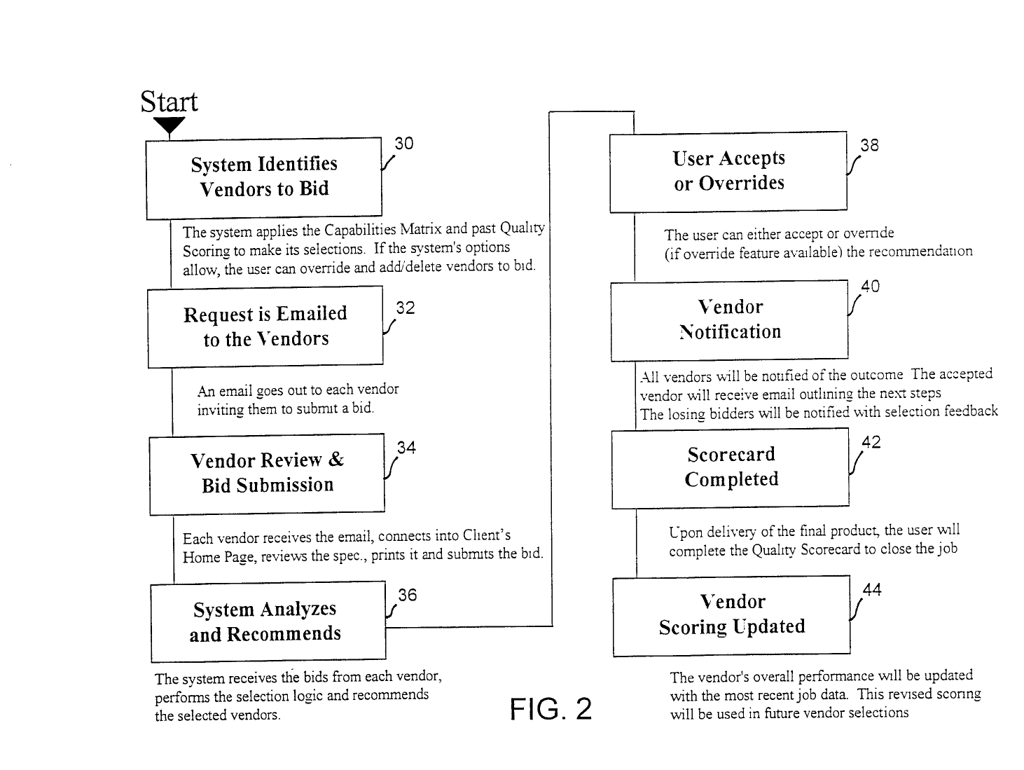

FIG. 2 summarizes the operation of the inventive system, from the bid submission to the job completion stages, in flowchart form. As indicated in box 30, the system identifies vendors that are selected to bid on the request. The system applies a capabilities matrix and past quality scoring to select appropriate vendors. The user can be provided with the capability of overriding the system selections and to add or delete vendors. At box 32, the request (bid package) is communicated to the selected vendors by, e.g., e-mail. At box 34, the vendors review the request and submit their bids via, e.g., the client's home page to which the vendors are directed by a link in the e-mail to the vendor.

The system then analyzes the bids received from the vendors, as indicated at box 36, and makes a recommendation to the user as to which vendor should be awarded the job. The recommendation process is described hereinabove, and uses selection logic that is programmed into the system. At box 38, the user accepts or overrides the system recommendation. Then, as indicated at box 40, the vendors are notified of the outcome. The winning vendor will be instructed as to the next steps required to complete the job, and the other vendors will be notified and provided with feedback as to why they were not selected.

Upon receipt of the job from the vendor, the user will complete, via the system user interface, a quality scorecard (box 42). The completion of the scorecard is required to close the job, and the vendor scores in various categories provided by the scorecard are stored by the system for use in future vendor selection, as indicated at box 44.

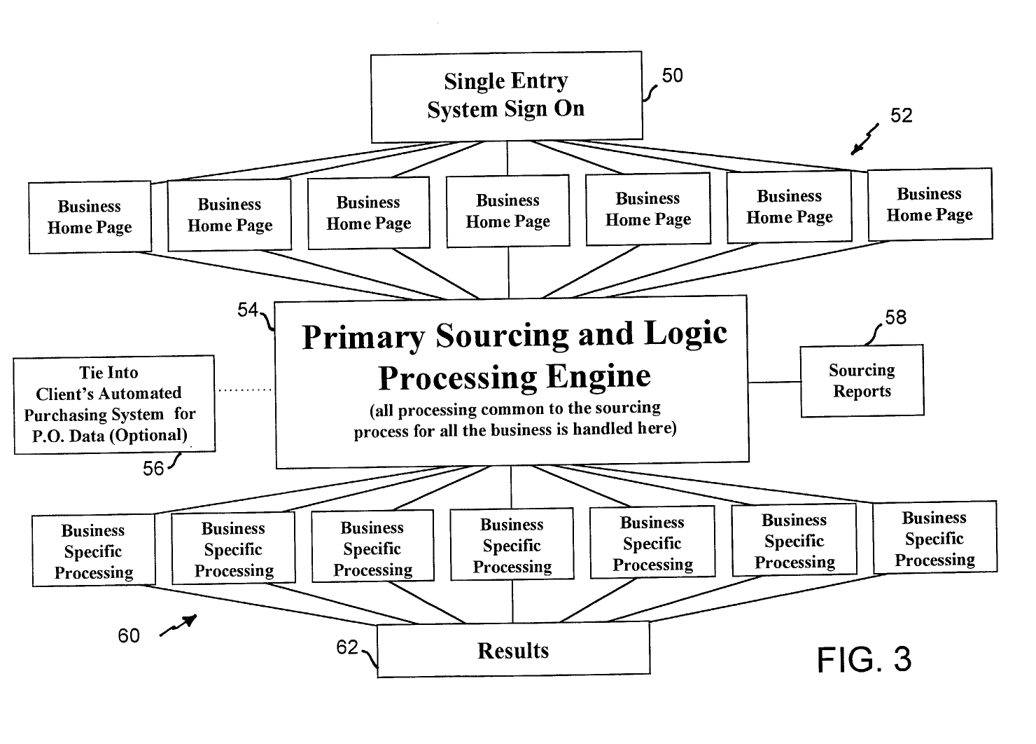

FIG. 3 illustrates the communication of a central processor with various business entities and vendors in accordance with the invention. In the preferred embodiment, a single entry system sign on is provided, as indicated at box 50. When a vendor signs on in response to an e-mail or other communication that it has been selected to bid on a job, the vendor will be directed to the appropriate “home page” 52 of the business (or business department) that is requesting the bid. All processing common to the sourcing process for all of the business entities served by the system is handled by a primary sourcing and logic processing engine 54. As will be appreciated from the discussion of the various software components set forth hereinabove, this processing engine may actually comprise a plurality of computers, such as personal computers (PCs) and network servers tied together for efficiency.

The engine 54 may optionally be tied into the client's automated purchasing system to obtain purchase order (P.O.) data as indicated at box 56. Reports related to the process will be provided from the processing engine and a database of information, as indicated at 58.

Business specific processing is provided by client computers 60. This processing may comprise, for example, payment arrangements and local data input that is completed at the client location, but is available to the engine 54 on an as needed basis. Results of the sourcing effort and job completion are provided to the user via the client computers 60, as indicated at box 62.

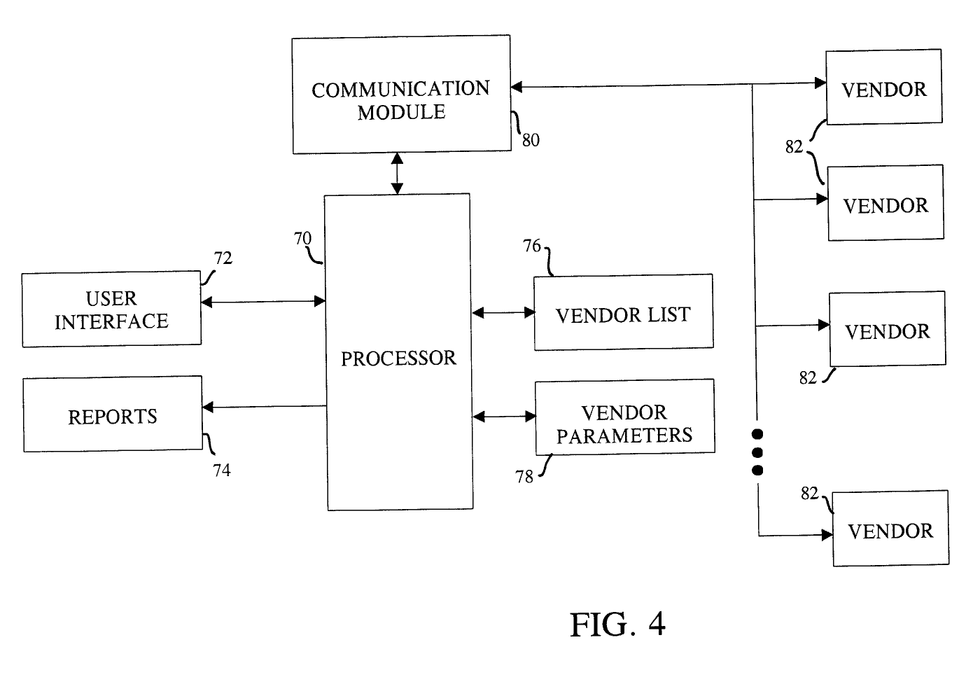

FIG. 4 is a high level block diagram showing the various components of the inventive system from a user's perspective. A processor 70, which can comprise, for example, a PC or a plurality of networked PCs, accepts user input from user interface 72. Reports from the system are provided to the user, as indicated at 74. Such reports can comprise, e.g., status reports as to the progress of a procurement project, accounting reports, vendor quality reports, listings of vendor parameters, and the like.

The list of vendors maintained by the system is stored in a data store (e.g., a database) as indicated at 76. Parameters pertaining to each vendor in the list are stored in a data store 78, which can be the same physical memory used for the vendor list 76, or a separate memory. As well known in the art, such databases can be stored on any type of non-volatile memory, such as a hard drive.

A communication module 80 is provided to allow the system to communicate with the different vendors 82. The communication can be provided, e.g., via the Internet or any other network. The communication module will contain the necessary hardware and software to transmit and receive signals to and from the various vendors, as well known in the art. For example, both e-mail and web-based communications can be provided via the communication module 80.

It should now be appreciated that the present invention provides a Business-to-Business Web-based system that automates the process of purchasing goods and/or services from vendors. An employee of an organization using the system generates a request for a product or service through the filling out of a detailed specification. The system matches all (or the most qualified) vendors who are capable of providing the product or service being requested. The vendors are notified (e.g., via e-mail) that a bid is required. A web-based link brings the vendor directly to a personal home page where they submit the bid information. At the end of the bidding period, or once all vendors have submitted their bids, the top vendor is selected by the system based on the desired criteria and an internally maintained rating system. The requesting employee (or a manager) can select which vendor the organization wishes to award the job to.

Both the vendor selected and the vendors not selected are informed of the decision (e.g., via e-mail). After the goods are received, the organization's employee (or manager or other designated individual) is requested to complete an evaluation of the vendor, which when fed back into the system, is taken into consideration in future selections of that vendor.

Various different employees of the organization requiring the product or service can interact with the system. Examples include the Requisitioner/Purchaser, i.e., the person requesting the goods or services. Other individuals include one or more members of the Purchasing Department, i.e., the person(s) responsible for creating and maintaining vendor relations. Employees working in the Financial Department may also be involved, e.g., person(s) requiring reports of cash flow and expenditures.

The Vendor also interacts with the system, in order to submit bids and examine their customer feedback. A system Administrator maintains system parameters such as cycle times and rating criteria, etc.

The general process flow is as follows:

Requisitioner/Purchaser determines their need and completes the creative specification, including all details needed by a vendor to properly execute the request.

Upon completion of the specification, the requestor will click a button to submit RFQs. The system matches the job needs to all the vendor profiles and selects, e.g., three vendors who meet the technical requirements and have the highest quality scores. The system creates an e-mail for each vendor inviting them to bid on the project and submit their quote details within a specified time period, e.g., 24 hrs.

Each vendor receives the e-mail. They click a link that will take them to their homepage. From this point, they can review the creative specification and submit all their pricing and timing information.

The system keeps track of each of the three vendors' input. Once all three have responded, the system makes a recommendation as to which vendor should be selected. A first alternate is also identified by the system.

The manager selects which vendor will be awarded the project and e-mails go back to all three, informing them of the decision. They will be asked to revisit their homepages for specific feedback on how they faired on the bid.

The system implementation described herein is designed with a specific type of purchasing in mind, i.e., printing of business materials. Various modifications may be made, without departing from the scope of the invention, to accommodate different types of purchasing, including parts for manufacturing, office supplies, telecommunications equipment, computer equipment, office furnishings, factory furnishings, food and beverages, and the like.

Additional features that can be provided in accordance with the invention include funneling all business through the system, even in cases where there is no bidding or vendor selection required. Business reporting capabilities can also be greatly expanded. Financial reporting capabilities will allow the business organization using the system to track and report on all levels of purchasing activity (i.e. total annual expenditures, total spent on specific items, total spent with specific vendors, year to year analysis, etc.). The ability to handle the negotiation process can also be facilitated using the system of the present invention. In addition to handling bidding, the system can be implemented to provide price negotiation and resubmission features. Moreover, sophisticated administration tools may be included to adjust, add, delete, modify or correct many of the system parameters and built-in functions.

Administration privileges allow for system overrides with trackability for all overrides and their associated justifications.

Although the invention has been described in connection with a preferred embodiment, it should be appreciated that numerous modifications and adaptations may be made thereto without departing from the scope of invention as set forth in the claims.

What is claimed is:

1. An automated rule-based procurement system, comprising:
at least one computer processor;
a data store of vendors accessible to said computer processor;
a data store of vendor parameters relating to said vendors and accessible to said computer processor for use in selecting vendors for a project; and
a user interface operatively associated with said processor for enabling the user to specify requirements for said project;
wherein said rule-based system applies rules to select at least one potential vendor for said project based on the vendor parameters and the project requirements specified by said user.

2. A system as defined in claim 1, further comprising:
a communication module adapted to communicate said project requirements to at least one selected vendor for solicitation of a bid on the project.

3. A system as defined in claim 2, wherein said communication module communicates with said at least one selected vendor by e-mailing a link to the vendor, said link directing said vendor to a web page for accessing said project requirements.

4. A system as defined in claim 3 wherein said at least one selected vendor submits a bid to the system via said web page.

5. A system as defined in claim 2, wherein:
bids are received from a plurality of selected vendors in response to said solicitation; and
said rule-based system applies rules to recommend one of said vendors to complete the project based on the received bids.

6. A system as defined in claim 5, wherein the rule-based system also bases its recommendation of a vendor on said vendor parameters.

7. A system as defined in claim 5, wherein said user interface permits a user to accept or override the system vendor recommendation.

8. A system as defined in claim 5, further comprising a vendor notification module, for notifying vendors of the outcome of the bidding process.

9. A system as defined in claim 5, further comprising a scoring module for receiving input from said user interface as to the quality of the project when completed by a vendor.

10. A system as defined in claim 9, wherein data from said scoring module is stored in said data store of vendor parameters for use in subsequent vendor selection.

11. A system as defined in claim 1, wherein said user interface permits a user to accept or override the system vendor selection.

12. A system as defined in claim 1, further comprising a system administrator interface for enabling an authorized administrator to manage at least one of:
(a) the project specification process,
(b) the vendor data store,
(c) the vendor parameters,
(d) the user interface,
(e) the rules to be applied, and
(f) vendor communications.

13. A system as defined in claim 1, further comprising a reporting module responsive to said user interface for generating reports relating to said project.

14. An automated method for procuring goods or services, comprising:
storing a list of vendors and associated vendor parameters in a database accessible to a computer processor;
providing a user interface operatively associated with said processor, for enabling dialog between a user and a procurement application running on the processor, said interface enabling the user to specify procurement requirements; and
applying rules via said procurement application to select at least one potential vendor based on the vendor parameters and procurement requirements.

15. A method in accordance with claim 14, comprising:
identifying said at least one potential vendor to said user.

16. A method in accordance with claim 15, comprising:
allowing said user to accept or override the identified at least one potential vendor.

17. A method in accordance with claim 14, further comprising:
communicating said procurement requirements to at least one selected vendor for solicitation of a bid on the procurement.

18. A method in accordance with claim 17, wherein said communicating step comprises e-mailing a link to the vendor, said link directing said vendor to a web page for accessing said procurement requirements.

19. A method in accordance with claim 18, comprising:
receiving a bid from the at least one selected vendor via said web page.

20. A method in accordance with claim 17, further comprising:
receiving bids from a plurality of selected vendors; and
applying rules via said procurement application to recommend one of said vendors to provide goods or services based on the submitted bids.

21. A method in accordance with claim 20, wherein the recommendation of a vendor is also based on said vendor parameters.

22. A method in accordance with claim 20, wherein said user interface permits a user to accept or override the system vendor recommendation.

23. A method in accordance with claim 20, further comprising notifying vendors of the outcome of the bidding process.

24. A method in accordance with claim 20, further comprising receiving input from said user interface as to the quality of a vendor's performance upon completion of a job.

25. A method in accordance with claim 24, wherein the user input is maintained for use in subsequent vendor selection.

26. A method in accordance with claim 14, further comprising permitting said user to accept or override the vendor selection.

27. A method in accordance with claim 14, further comprising enabling an authorized administrator to manage at least one of:
(a) the procurement specification process,
(b) the list of vendors,
(c) the vendor parameters,
(d) the user interface,
(e) the rules to be applied, and
(f) vendor communications.
